(19) United States
(12) Patent Application Publication
(10) Pub. No.: US 2012/0170543 A1
(43) Pub. Date: Jul. 5, 2012

(54) WIRELESS TRANSMISSION APPARATUS, WIRELESS RECEPTION APPARATUS, AND WIRELESS COMMUNICATION METHOD

(75) Inventor: Yutaka ASANUMA, Kawasaki (JP)

(73) Assignee: FUJITSU TOSHIBA MOBILE COMMUNICATIONS LIMITED, Kawasaki-shi (JP)

(21) Appl. No.: 13/422,995

(22) Filed: Mar. 16, 2012

Related U.S. Application Data
(62) Division of application No. 12/558,763, filed on Sep. 14, 2009.

(30) Foreign Application Priority Data
Mar. 19, 2009 (JP) 2009-067294

(51) Int. Cl. H04W 72/04

(52) U.S. Cl. 370/329

(57) ABSTRACT

A wireless base station apparatus notifies a mobile wireless terminal apparatus of a channel to be used to transmit a response signal of channel assignment by a mapping pattern of channel assignment information transmitted on a plurality of bands.

### CROSS-REFERENCE TO RELATED APPLICATIONS

This patent application is a divisional of U.S. patent application No. 12/558,763, filed Sep. 14, 2009, which claims priority to Japanese Application No. 2009-067294, filed Mar. 19, 2009. The foregoing patent applications are incorporated herein by reference.

### BACKGROUND OF THE INVENTION

1. Field of the Invention

The present invention relates to communication between a wireless base station apparatus and a mobile wireless terminal apparatus which are accommodated in a network.

2. Description of the Related Art

A mobile communication system such as a cellular system uses various parameters for defining the transmission/reception capability of a terminal to support terminals of various application purposes (e.g., 3CPP (3rd Generation Partnership Project) TS 36.306 V8.2.0 (2008 05)). Combinations of parameters define UE categories. Terminal capabilities (UE capabilities) that define the UE categories include a maximum information transmission rate which is defined on each of the transmitting and receiving sides. A base station transmits/receives signals to/from a plurality of terminals based on their different transmission and reception capabilities. The 3GPP (3rd Generation Partnership Project) IS 36.306 V8.2.0 (2008 05) suggests that a base station should be able to simultaneously connect terminals of different categories.

Recently, an LTE-Advanced (LTE-A) system has been examined, which uses a broadband including a system band that is the receivable bandwidth of a Rel-8 LTE terminal. To operate the Rel-8 LTE terminal using a narrowband in the new system using a broadband, the base station of the new system needs to transmit a signal that is receivable by the Rel-8 LTE terminal as well.

The Rel-8 LTE terminal starts its operation ahead of the new system. It is therefore difficult to change the reception band of the Rel-8 LTE terminal later at the start of the operation of the new system. In addition, the ratio of Rel-8 LTE terminals that exist in the radio zone of one base station to terminals (“LTE-A terminals” hereinafter) that use the broadband there dynamically changes. For this reason, the LTE system that assigns information transmission channels via control channels requires some contrivance on the control channel configuration.

The control channels are transmitted using a common resource. The Rel-8 LTE terminal and the LTE-A terminal perform blind determination and detect control information addressed to them. A downlink physical channel transmitted from the base station multiplexes a physical downlink control channel (PDCCH) and a physical downlink shared channel (PDSCH) (e.g., 3GPP TS 36.211 V8.3.0 [2008-05] 6.8, Physical downlink control channel, 3GPP TS 36.212 V8.3.0 [2008-05] 5.3.3, Downlink control information, and 3GPP TS 36.213 V8.3.0 [2008-05] 7, Physical downlink shared channel related procedures).

A terminal receives the PDCCHs and detects the assignment information of information transmission channels PDSCH of the terminal based on the PDCCHs for the terminal. The terminal then receives the PDCCHs based on the PDSCH assignment information. The PDCCHs are scrambled in different ways for the respective terminals. Each terminal decodes the PDCCHs using a unique decoding method and determines a correctly detected PDCCH as the PDCCH for the terminal. This processing is called blind detection.

As the control channel transmission method, control information for a Rel-8 LTE terminal and that for a broadband terminal may be transmitted using different resources. However, this resource use method cannot be efficient because the terminal existence ratio dynamically changes, as described above.

For this reason, there is a demand for development of a system which allows a Rel-8 LTE terminal to receive PDCCHs without changing its specifications and an LTE-A terminal to efficiently receive PDCCHs.

Especially, when an LTE-A terminal (narrowband reception apparatus) uses a plurality off bands used by a Rel-8 LTE terminal (broadband reception apparatus), the wireless base station may assign, to the LTE-A terminal, PDSCHs to be used in the respective bands via the PDCCHs of the corresponding bands. In this case, the LTE-A terminal responds to the PDCCHs of the respective bands. However, this response is inefficient.

### BRIEF SUMMARY OF THE INVENTION

The present invention has been made to solve the above problems, and has as its object to provide a wireless transmission apparatus, a wireless reception apparatus, and a wireless communication method, which allow a broadband reception apparatus using the channels of a plurality of bands to efficiently respond to control channels which assign transmission channels via the respective bands.

To achieve the object, an aspect of the present invention is a wireless transmission apparatus which assigns channels of a plurality of bands to a wireless reception apparatus, notifies the wireless reception apparatus of channel assignment information of each band, and performs data transmission via the assigned channels of the plurality of bands. The wireless transmission apparatus comprises a pattern selection unit which selects a mapping pattern in accordance with a channel to be used by the wireless reception apparatus to transmit a response signal; a transmission unit which transmits the channel assignment information of each band by mapping the channel assignment information on the plurality of bands in accordance with the pattern selected by the pattern selection unit; and a reception unit which receives the response signal from the wireless reception apparatus via a channel corresponding to the pattern selected by the pattern selection unit.

As described above, in the present invention, a wireless transmission apparatus notifies a wireless reception apparatus of a channel to be used to transmit a response signal of channel assignment by a mapping pattern of channel assignment information transmitted on a plurality of bands.

Hence, according to the present invention, the wireless transmission apparatus and the wireless reception apparatus can have a consensus on a channel to be used to transmit a response signal without consuming any special radio resource. It is therefore possible to provide a wireless transmission apparatus, a wireless reception apparatus, and a transmission method, which allow a reception apparatus using the channels of a plurality of bands to efficiently respond to control channels which assign transmission channels via the respective bands.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining communication bands used in a wireless communication system according to the present invention;

FIG. 2 is a view for explaining a resource block assigned to subcarriers shown in FIG. 1;

FIG. 3 is a view for explaining channels assigned to the resource block shown in FIG. 2;

FIG. 4 is a block diagram showing the arrangement of a wireless base station in a wireless communication system according to an embodiment of the present invention;

FIG. 5 is a block diagram showing the arrangement of a mobile wireless terminal in the wireless communication system according to the embodiment of the present invention;

FIG. 6 is a view for explaining mapping processing of assignment information to be transmitted to the mobile wireless terminal;

FIG. 7 is a view showing examples of patterns of the mapping processing shown in FIG. 6;

FIG. 8 is a view for explaining PUCCH decision processing in the mobile wireless terminal;

FIG. 9 is a view for explaining a modification of mapping processing of assignment information to be transmitted to the mobile wireless terminal;

FIG. 10 is a view showing an example of a convolutional coder which performs tail biting; and

FIG. 11 is a view for explaining the characteristics of tail biting.

### DETAILED DESCRIPTION OF THE INVENTION

An embodiment of the present invention will now be described with reference to the accompanying drawing.

A wireless communication system according to the present invention will be described by exemplifying a cellular system using OFDM in the downlink. This wireless communication system includes mobile wireless terminals and a wireless base station and performs wireless communication using OFDM in the downlink transmitted from the wireless base station and received by the mobile wireless terminals. There are two types of mobile wireless terminals, i.e., a type x conforming to Rel-8 LTE system and a type y conforming to LTE-A Advanced (LTE-A) system. The wireless base station transmits signals to a plurality of mobile wireless terminals of type x and a plurality of mobile wireless terminals of type y.

The maximum receivable bandwidth of the mobile wireless terminal of type x is one component (18.05 MHz). The maximum receivable bandwidth of the mobile wireless terminal of type y is 60 MHz including three components. The wireless base station transmits signals receivable by the mobile wireless terminals of both types. The maximum reception bandwidth of the mobile wireless terminal of type y will be exemplified as 60 MHz here. However, it may be n×20 MHz (n is a natural number of 2 or more).

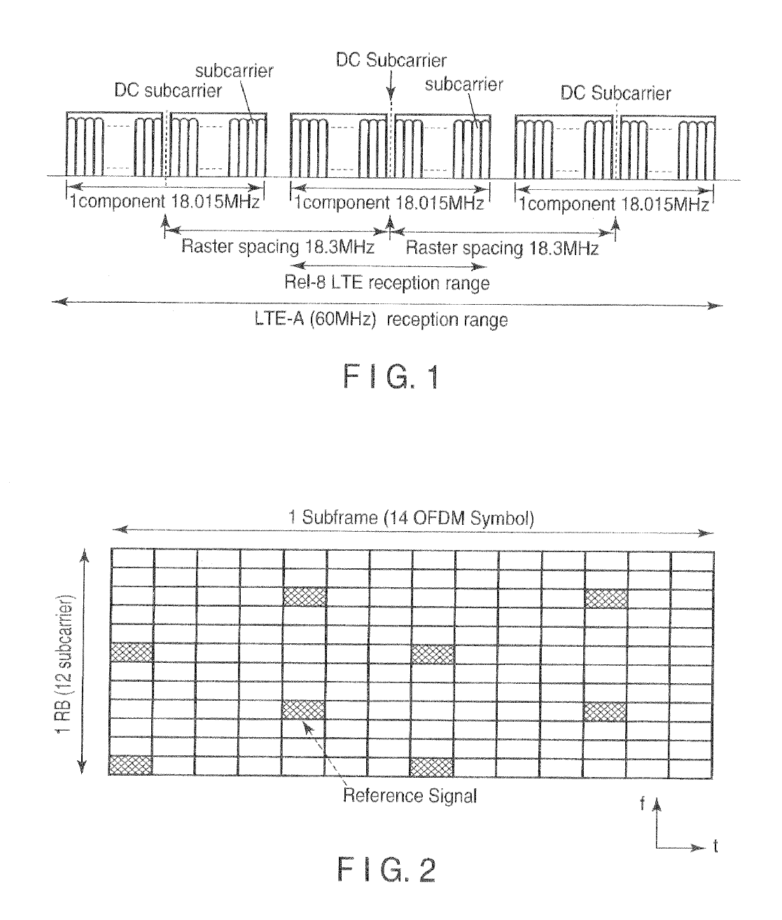

As shown in FIG. 1, the wireless base station arranges a DC subcarrier at the center frequency of one component, thereby forming a transmission signal band of 18.015 MHz (number of subcarriers=1201). That is, the subcarrier spacing is 15 kHz. Note that the wireless base station transmits no signal on the DC subcarrier. In addition, the wireless base station forms one resource block (RB) by a 180 kHz and width containing 12 subcarriers, as shown in FIG. 2. Hence, one component includes 100 RBs.

Note that an RB includes 14 symbols in the time direction. Reference signals which are known signals as the reference of a received signal are inserted. The system description may regard the transmission signal bandwidth as 18 MHz and the guard bandwidth as 2 MHz (1 MHz on each side) excluding the DC subcarrier.

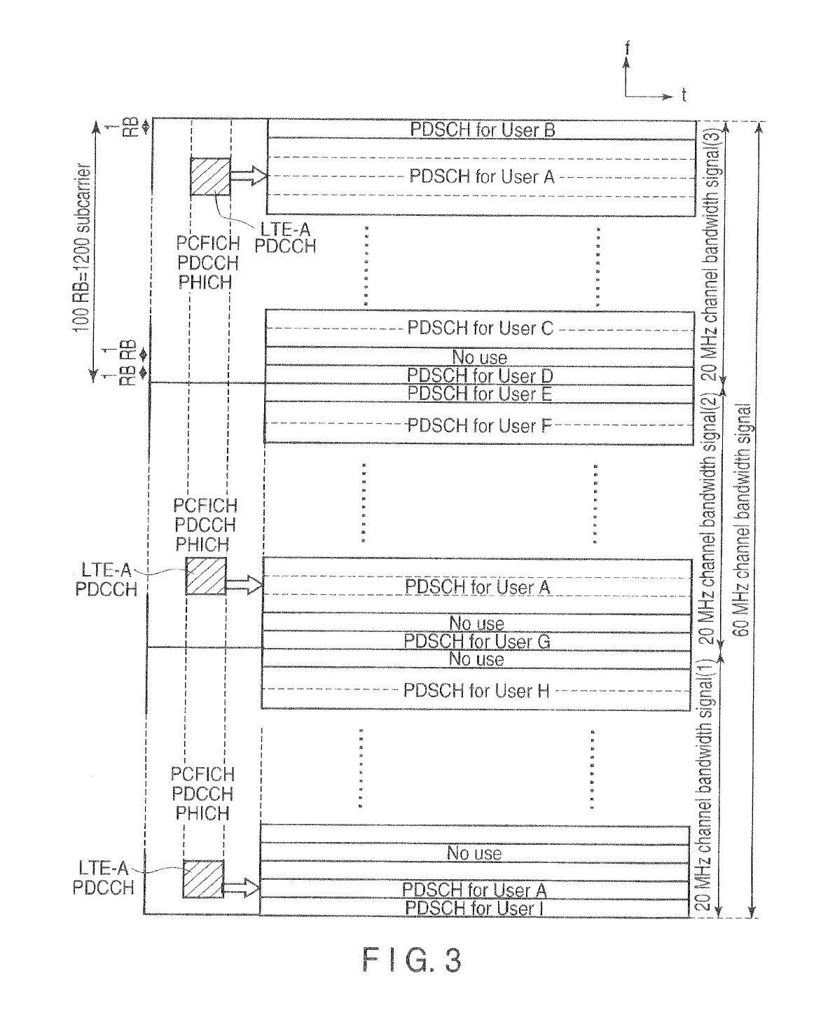

FIG. 3 shows the structure of a transmission signal of one subframe the wireless base station transmits to the mobile wireless terminals of types x and y. In FIG. 3, the RRs are arranged in the frequency direction. The signal transmitted from the wireless base station to the mobile wireless terminals of types x and y includes control channels (PCFICH, PDCCH, and PHICH) to transmit control information and data channels (PDSCH) to transmit transmission information. These channels are time-divisionally distributed and transmitted.

As described above, the mobile wireless terminal of type x can receive one component. One or more RBs in the component are assigned via PDCCHs which are sent from the wireless base station for PDSCH reception. That is, referring to FIG. 3, the mobile wireless terminal of type x corresponds to one of Users B, C, D, E, F, G, H, and I.

On the other hand, the mobile wireless terminal of type y can receive three components at the same time. The wireless base station assigns one or more RBs in the components for PDSCH reception. That is, it is possible to assign, to the mobile wireless terminal of type y, either only RBs belonging to a single component for PDSCH reception or RBs belonging to a plurality of different components for PDSCH reception.

Note that the present invention will be described below using an example for the sake of simplicity in which PDSCHs belonging to the three components are assigned to the mobile wireless terminal of type y. That is, a case will be explained in which the mobile wireless terminal of type y corresponds to User A in FIG. 3.

Each of the mobile wireless terminals of types x and y receives the PDCCHs for it. Based on the information, each mobile wireless terminal specifies the RBs to which the PDSCHs for the terminal are assigned and receives only the specified RBs (PDSCHs) for the terminal. More specifically, the wireless base station makes PDSCHs include assignment information representing which PDSCHs are assigned to which mobile wireless terminal.

The wireless base station multiplexes and arranges the PDCCHs for the respective mobile wireless terminals throughout the signal band. The arrangement positions are not fixed for the respective mobile wireless terminals. For this reason, each mobile wireless terminal needs to search for (blind-detect) PDCCHs addressed to it from the multiplexed PDCCHs.

The mobile wireless terminal of type x can use only one component. Hence, the wireless base station arranges PDCCHs and PDSCHs for each mobile wireless terminal of type x in a single component so that the mobile wireless terminal of type x need only perform blind detection in one component. On the other hand, the mobile wireless terminal of type y can use a broadband including three components, as shown in FIG. 3. For this reason, the wireless base station can distribute PDCCHs on the broadband.

The distributed arrangement requires the mobile wireless terminal of type x to perform a search throughout the signal band. However, it also enhances the frequency diversity effect and improves the PDCCH reception quality.

An LTE-A system is implemented by expanding the standard of a Rel-8 LTE system. Conversely, the mobile wireless terminal of type x has no function of receiving the band and PDCCH structure expanded to the LTE-A standard. Even when the LTE-A system is introduced, the PDCCH structure receivable by the mobile wireless terminal of type x does not change from that in the Rel-8 LTE system. Hence, expansion to the LTE-A standard needs to be done not to cause any problem for reception by the mobile wireless terminal of type x.

The ratio of resources used for communication by the mobile wireless terminals of type x and the mobile wireless terminals of type y varies over time. For this reason, the wireless base station cannot determine in advance allocation of the resources to map the P DC CH s. The mobile wireless terminals of type x and the mobile wireless terminals of type y need to share the PDCCH resource. For this reason, each of the mobile wireless terminals of types x and y performs blind determination, i.e., receives a number of PDCCHs and searches for PDCCHs with coincident CRCs, thereby detecting the PDCCHs addressed to the terminal.

Each mobile wireless terminal can detect only PDC CHs addressed to it. Hence, each mobile wireless terminal of type x cannot know the total size of PDCCHs, i.e., the resource allocation of PDCCHs transmitted in the LTE-A standard. Similarly, each mobile wireless terminal of type y cannot know the total size of PDC CHs, i.e., the resource allocation of PDCCHs transmitted in the Rel-8 LTE standard. For these reasons, the mobile wireless terminals of type x and the mobile wireless terminals of type y preferably execute the same reception processing independently of the PDCCH resource allocation.

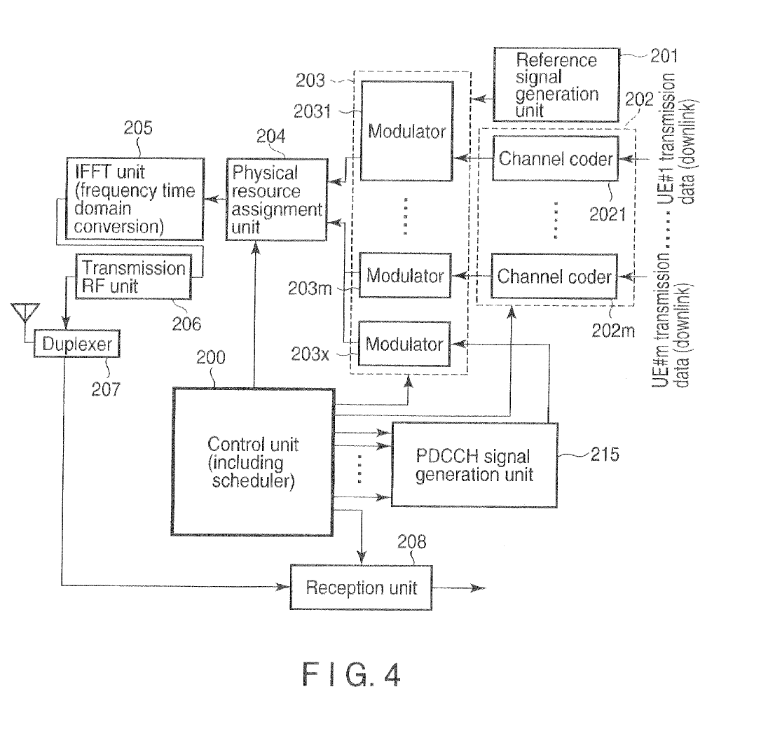

The arrangement of the wireless base station will be explained. FIG. 4 shows the arrangement.

A reference signal generation unit 201 generates a bitstream that is the base of a reference signal. The bitstream is scrambled and then output to a modulation unit 203. A channel coding unit 202 includes channel coders 2021 to 202m.

The channel coders 2021 to 202m channel-code transmission information (downlink transmission data bitstreams) to be transmitted via data channels at channel coding rate designated by a control unit 200. The channel coders 2021 to 202m output thus obtained downlink transmission data signals to the modulation unit 203. Note that the downlink transmission data bitstreams include data addressed to the mobile wireless terminals of type x and data addressed to the mobile wireless terminals of type y.

A PDCCH signal generation unit 215 receives PDCCH data generated by the control unit 200 and addressed to a mobile wireless terminal of type x or a mobile wireless terminal of type y. That is, the PDCCH signal generation unit 215 receives PDCCH data addressed to a terminal of the LTE-A system or a terminal of the Rel-8 LTE system. The PDCCH data include identification information of PDSCHs assigned to a terminal. The PDCCH signal generation unit 215 executes processing such as channel coding, multiplexing, and interleaving for the PDCCH data, thereby obtaining PDCCH signals.

Especially for three PDCCH data addressed to a terminal of the LTE-A system, the PDCCH signal generation unit 215 generates cyclic redundancy check (CRC) data based on these data, error-correction-codes the three PDCCH data and the CRC data, and divides the result into three PDCCH signals. The control unit 200 maps the three PDCCH signals on three components in accordance with a PUCCH to be used by the mobile wireless terminal of type y. Details of the process contents will be described later.

The modulation unit 203 includes modulators 2031 to 203m corresponding to the channel coders 2021 to 202m, respectively, and a modulator 203x corresponding to the PDCCH signal generation unit 215. In accordance with a modulation method designated by the control unit 200, the modulators 2031 to 203m and 203x perform digital modulation such as quadrature phase-shift keying (QPSK) for the reference signals, the downlink transmission data signals, and the PDCCH signals.

A physical resource assignment unit 204 receives the signals digitally modulated by the modulators 2031 to 203m and 203x and PCFICH signals and PHICH signals generated by the control unit 200. The physical resource assignment unit 204 assigns these signals to the subcarriers (resource blocks) of predetermined channels (control channels and data channels) designated by the control unit 200. Note that “assigning a signal to a subcarrier” indicates adding, to a signal expressed by a complex value, a subcarrier index representing the position on the time and frequency axes of a subcarrier in a corresponding resource block.

The channel band transmitted from the wireless base station is divided into the above-described RBs. Subcarriers arranged in each channel band. are put together into one RB. This can uniquely be obtained based on channel band information and the number of resource blocks sent from the wireless base station to each mobile wireless terminal in advance. The mobile wireless terminal also recognizes the RB structure. In the wireless base station, this is implemented by the control unit 200 and the physical resource assignment unit 204.

An inverse fast Fourier transformation (IFFT) unit 205 converts a frequency-domain signal output from the physical resource assignment unit 204 into a time domain signal. A transmission RF unit 206 including a digital-to-analog converter, an upconverter, and a power amplifier converts the signal into a radio-frequency (RF) signal. This radio signal is emitted into space, via a duplexer 207 and an antenna, for reception by the mobile wireless terminals.

A reception unit 208 receives, via the antenna and the duplexer 207, a radio signal transmitted from each mobile wireless terminal.

The control unit 200 comprehensively controls the units of the wireless base station. The control unit 200 includes a scheduler which decides, for each frame, which channel band should be assigned to which mobile wireless terminal and the packet to be used for transmission, based on, e.g., the type (x or y) of the standard (Rel-8 LTE or LTE-A) supported by each mobile wireless terminal, the amount of data for each mobile wireless terminal, and the priority and capabilities (UE capabilities) of each mobile wireless terminal.

The scheduler assigns resource blocks within the range of one component to a mobile wireless terminal of type x. On the other hand, the scheduler assigns resource blocks within the range of a broadband including three components at maximum to a mobile wireless terminal of type y.

Note that the capabilities (UE capabilities) of a mobile wireless terminal and the type of the standard supported by it are detected by the control unit 200 from data received from the mobile wireless terminal. Additionally, in accordance with information representing the channel band assigned to each mobile wireless terminal, the control unit 200 generates PCFICH, PDCCH, and PHICH including the information for the mobile wireless terminal and outputs the items of information to the PDCCH signal generation unit 215 and the physical resource assignment unit 204.

Hence, when the mobile wireless terminal of type y uses PDSCHs on three components, the scheduler maps three modulated signals generated based on three PDCCH signals generated by the PDCCH signal generation unit 215 on the PDCCHs of three components in accordance with one PUCCH to be used by the mobile wireless terminal of type y. That is, when using PDSCHs on three components, one of the total of three PUCCHs corresponding to the components can be used. One PUCCH to be used by the mobile wireless terminal of type y is designated by the mapping pattern.

Note that the wireless base station and the mobile wireless terminals of type y have a consensus in advance on the correspondence between a mapping pattern and a PUCCH to be used. More specifically, each of the wireless base station and the mobile wireless terminals of type y has a table representing the correspondence between a mapping pattern and a PUCCH to be used.

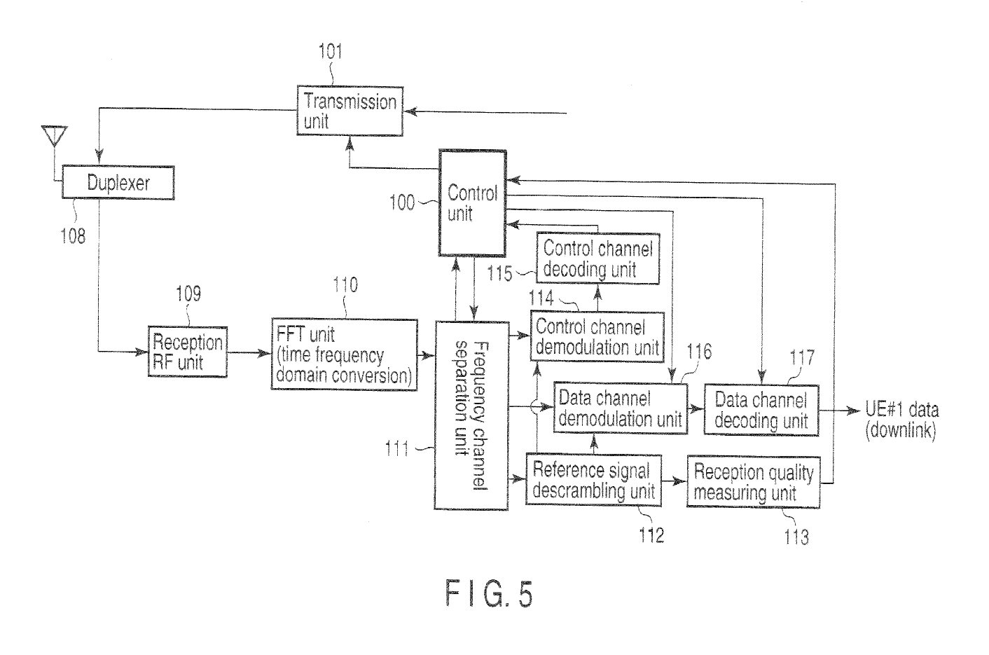

The arrangement of each mobile wireless terminal will be described. FIG. 5 shows the arrangement. As described above, the mobile wireless terminal of type x and the mobile wireless terminal of type y apparently have the same arrangement except for the number of components, the band to be used for reception, and the arrangement (processing) associated with reception. Hence, both terminals will be explained using FIG. 5.

A transmission unit 101 generates a radio signal for the wireless base station and emits the signal into the space via a duplexer 108 and an antenna.

The antenna receives a radio signal transmitted from the wireless base station and outputs it to a reception RF unit 109 via the duplexer 108. The reception RE unit 109 including a downconverter and an analog-to-digital converter converts the received radio signal into a baseband digital signal.

A fast Fourier transformation (FFT) unit 110 performs fast Fourier transformation of the baseband digital signal, thereby converting the time-domain signal into a frequency-domain signal, i.e., dividing the signal into subcarrier signals. The divided subcarrier signals are output to a frequency channel separation unit 111. Note that the wireless base station puts a predetermined number (e.g., 12) of subcarriers together into a resource block. The wireless base station assigns the subcarriers to a mobile wireless terminal for each resource block.

As for a channel hand and resource blocks designated by a control unit 100, the frequency channel separation unit 111 separates the subcarrier signals included in the resource blocks into reference signals, control channel signals, and data channel signals.

Note that in the mobile wireless terminal of type x, the process target of the frequency channel separation unit 111 is only the range of one component designated by the control unit 100. In the mobile wireless terminal of type y, the process target of the frequency channel separation unit 111 is a broadband designated by the control unit 100 and including three components at maximum.

In the mobile wireless terminal of type y, the frequency channel separation unit 111 detects the components to which the separated control channels have been mapped and sends the detection result (“mapping information” hereinafter) to a control channel demodulation unit 114.

Regarding how to divide a channel band into resource blocks, i.e., the correspondence between subcarriers and resource blocks, the wireless base station sends channel band information and the number of resource blocks to each mobile wireless terminal in advance. The correspondence between subcarriers and resource blocks is then obtained uniquely based on the channel band information and the number of resource blocks. That is, each mobile wireless terminal detects in advance how the wireless base station divides a channel band into resource blocks, and receives signals accordingly.

A reference signal descrambling unit 112 descrambles, out of the signals, the reference signal using a descrambling pattern opposite to the scrambling pattern used by the wireless base station which transmits the signal to be received by the mobile wireless terminal. The descrambling result is output to the control channel demodulation unit 114, a data channel demodulation unit 116, and a reception quality measuring unit 113. The reception quality measuring unit 113 measures the reception quality of Mogi resource blocks based on the reference signal. The measurement result is output to the control unit 100.

The control channel demodulation unit 114 performs channel equalization of the control channel signals output from the frequency channel separation unit 111 using the reference signal descrambled by the reference signal descrambling unit 112 and then demodulates them. The demodulation result is output to a control channel decoding unit 115 together with mapping information representing the components on which the control channels have been mapped.

The control channel decoding unit 115 detects the PCFICH and the PHICH for the terminal from the demodulated control channel signals. When receiving the signals via, e.g., three components, the control channel decoding unit 115 selects one control channel demodulation result per component, i.e., a total of three demodulation results, changes the sequence and multiplexes them in accordance with three patterns used by the wireless base station, and attempts error correction decoding.

The control channel decoding unit 115 repeats this processing until the PDCCHs addressed to the terminal are detected. That is, the control channel decoding unit 115 executes decoding while changing the combination of demodulation results or mapping pattern (multiplex order). A mapping pattern for successful decoding is detected. The bitstreams of the control channels (PCFICH, PHICH, and PDCCH) obtained by the decoding processing are output to the control unit 100.

The control unit 100 comprehensively controls the units of the mobile wireless terminal. The control unit 100 controls the units (e.g., frequency channel separation unit 111) of the reception system to detect, based on the PDCCH information acquired from the control channels, the data channels (channel band and resource blocks) assigned to the mobile wireless terminal and receive data from the wireless base station via the data channels. Upon determining that the received signal is addressed to the mobile wireless terminal, the control unit 100 extracts signaling information contained in the signal and detects, from it, information necessary for demodulating data channel signals and information necessary for decoding them.

The information necessary for demodulating the data channel signals is output to the data channel demodulation unit 116. The information necessary for decoding the data channel signals is output to a data channel decoding unit 117. Upon determining that the received signal is not addressed to the mobile wireless terminal, the control unit 100 stops the processing of demodulating and decoding the data channel signals.

In the mobile wireless terminal of type y, the control unit 100 selects, out of the three PUCCHs corresponding to the components to be used for reception, a PUCCH corresponding to the mapping pattern detected by the control channel decoding unit 115. The control unit 100 then transmits, via the selected PUCCH, Ack or Nack to the wireless base station in association with assignment of data channels to the terminal.

The control unit 100 detects the PDSCHs assigned to the terminal based on the PDCCHs. The control unit 100 controls the data channel demodulation unit 116 and the data channel decoding unit 117 to receive the detected

PDSCHs. More specifically, in the mobile wireless terminal of type x, the control unit 100 instructs the data channel demodulation unit 116 and the data channel decoding unit 117 to receive PDSCHs for the terminal which fit within the range of one component. On the other hand, in the mobile wireless terminal of type y, the control unit 100 instructs the data channel demodulation unit 116 and the data channel decoding unit 117 to receive PDSCHs for the terminal which fit within the range of a broadband including three components at maximum.

The data channel demodulation unit 116 performs channel equalization of the signals output from the frequency channel separation unit 111 using the reference signal output from the reference signal descrambling unit 112. The data channel demodulation unit 116 then demodulates the PDSCHs designated by the control unit 100 based on a demodulation method designated by the control unit 100 and information output from it.

The data channel decoding unit 117 decodes the demodulated data bitstreams to obtain a downlink data bitstream for the mobile wireless terminal. Decoding here uses the information output from the control unit 100. Before data reception from the wireless base station, the type (x or y) and capabilities (UE capabilities) of the mobile wireless terminal are transmitted to the wireless base station via the uplink.

Processing of causing the wireless base station to transmit PDCCHs to a mobile wireless terminal will be described next with reference to FIGS. 4, 6, and 7. For the sake of simplicity, processing of transmitting PDCCHs addressed to one mobile wireless terminal of type y (User A) will be explained below. In fact, PDCCHs are transmitted to a number of mobile wireless terminals of type y by the same processing as will be described later, and in parallel with this, PDCCHs arc transmitted to a number of mobile wireless terminals of type x.

First, the control unit 200 decides to transmit transmission information to the mobile wireless terminal of type y of User A (“mobile wireless terminal A” hereinafter) via three components. The control unit 200 also decides PDSCHs to be used in the respective components.

The control unit 200 generates items of PDSCH assignment information 1 to 3 which represent the identification information of the PDSCHs to be used in the components. The control unit 200 then generates three PDCCH data respectively including PDSCH assignment information 1 to 3 and outputs them to the PDCCH signal generation unit 215.

The control unit 200 also decides a PUCCH which corresponds to a component and is to be used by mobile wireless terminal A, and selects, as the mapping pattern corresponding to the decided PUCCH, one of patterns in FIG. 7 which are prepared in advance. The control unit 200 notifies the physical resource assignment unit 204 of the selected mapping pattern.

Upon receiving the three PDCCH data from the control unit 200, the PDCCH signal generation unit 215 generates CRC data based on these data, error-correction-codes the three PDCCH data and the CRC data, and divides the result into three PDCCH signals 1 to 3. The PDCCH signal generation unit 215 outputs three PDCCH signals 1 to 3 to the modulator 203x.

In accordance with a modulation method designated by the control unit. 200, the modulator 203x performs digital modulation such as quadrature phase-shift keying (QPSK) for three PDCCH signals 1 to 3 and outputs three signals thus obtained to the physical resource assignment unit 204.

The physical resource assignment unit 204 maps the three signals received from the modulator 203x on predetermined components in accordance with the mapping pattern sent from the control unit 200. With this processing, the three PDCCH data for mobile wireless terminal A generated by the control unit 200 are transmitted by the mapping pattern corresponding to the PUCCH to be used by mobile wireless terminal A.

The inverse fast Fourier transform unit 205 converts the thus mapped frequency-domain signals into time-domain signals. Then, the transmission RF unit 206 converts the signals into radio signals and emits them into the space for the mobile wireless terminal via the duplexer 207 and the antenna.

From then on, the wireless base station waits for Ack or Nack sent from mobile wireless terminal A that has received the PUCCH corresponding to the mapping pattern.

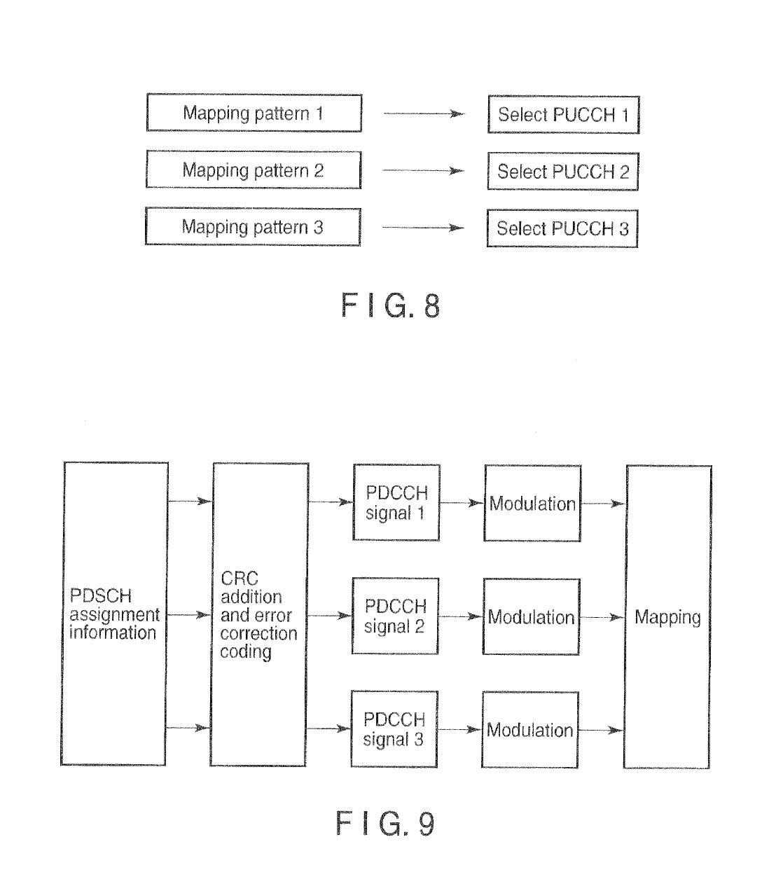

Processing of causing mobile wireless terminal A to receive the PDCCHs from the wireless base station and subsequently transmit the PUCCH will be described next with reference to FIGS. 5 and 8.

The radio signals transmitted from the wireless base station are received by the antenna and output to the reception RF unit 109 via the duplexer 108. The reception RF unit 109 converts the received radio signals into baseband digital signals.

The frequency channel separation unit ill separates, out of the baseband digital signals, signals in the channel bands and the resource blocks designated by the control unit 100 into reference signals, control channel signals, and data channel signals. The reception targets here are the baseband digital signals of the three components that are the reception targets of mobile wireless terminal

A.

The frequency channel separation unit 111 also detects the components on which the separated control channel signals have been mapped and notifies the control channel demodulation unit 114 of the detection result (mapping information). The control channel demodulation unit 114 recognizes the components on which the control channel signals have been mapped.

In this way, the control channel demodulation unit 114 demodulates the control channel signals obtained by the frequency channel separation unit 111. The demodulation result is associated with the mapping information and output to the control channel decoding unit 115.

The control channel decoding unit 115 selects one control channel demodulation result per component, changes the sequence and multiplexes them in accordance with three patterns used by the wireless base station, and attempts error correction decoding. The control channel decoding unit 115 repeats this processing until the PDCCHs addressed to the terminal are detected. When decoding has normally ended, and the PDCCHs for the terminal have been detected, the control channel decoding unit 115 outputs the mapping pattern (multiplex order) used at that time to the control unit 100 together with the decoding result.

The control unit 100 detects the PDSCHs assigned to the terminal from the decoded PDCCH data and determines whether data transmission is appropriate. The control unit 100 also selects, from the three PUCCHs corresponding to the components to be used for reception, the PUCCH corresponding to the mapping pattern detected by the control channel decoding unit 115. The control unit 100 transmits Ack or Nack to the wireless base station via the selected PUCCH in accordance with the determination result.

As described above, in the wireless communication system having the above arrangement, the wireless base station designates, using a PDCCH mapping pattern, a PUCCH to be used by mobile wireless terminal A which performs data reception via three components.

Hence, according to the wireless communication system having the above arrangement, the wireless base station can designate a PUCCH to be used by mobile wireless terminal A without consuming a radio resource. Since mobile wireless terminal A and the wireless base station use only a specific: PUCCH recognized by them, mobile wireless terminal A can efficiently respond to the wireless base station,

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

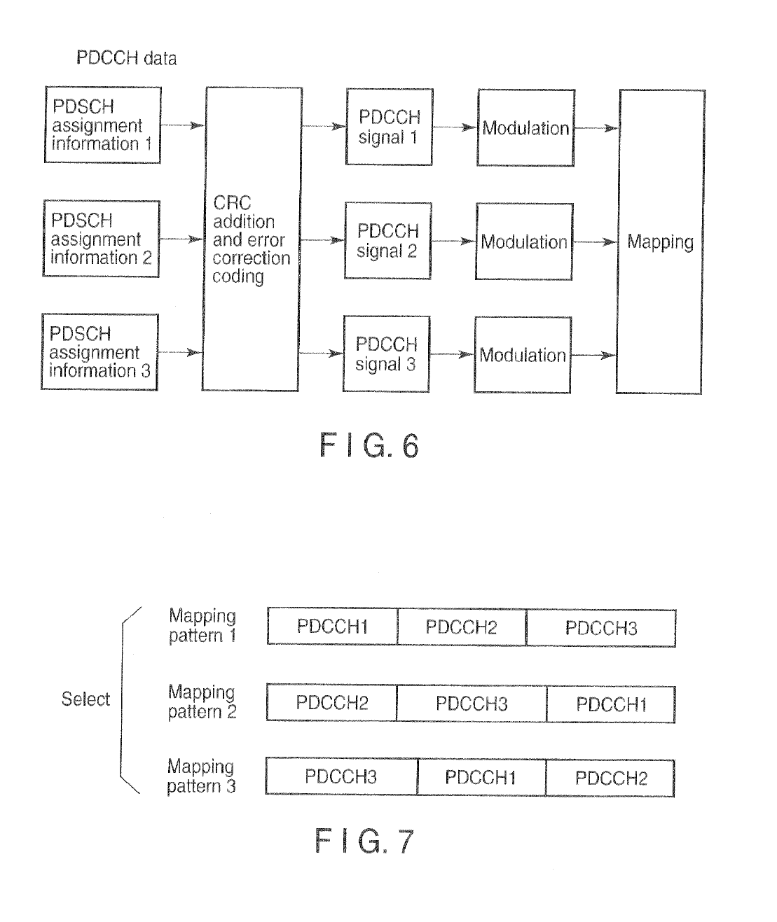

For example, in the above embodiment, an example in which three PDCCH data corresponding to three components are transmitted, as shown in FIG. 6, has been described. More specifically, three PDCCH data respectively indicate the identification information of PDSCHs assigned to the terminal for corresponding components.

Instead, for example, one PDCCH data may indicate the identification information of PDSCHs on three components assigned to mobile wireless terminal A, as shown in FIG. 9. In this case, the wireless base station causes the control unit 200 to generate one PDCCH data and supply it to the PDCCH signal generation unit 215. The PDC CH signal generation unit 215 generates CRC data based on the one PDCCH data, error-correction-codes the one PDCCH data and the CRC data, and divides the result into three PDCCH signals 1 to 3. The PDCCH signal generation unit 215 outputs three PDCCH signals 1 to 3 to the modulator 203x. The subsequent processing is the same as described above.

Note that in this case, the control channel decoding unit 115 in mobile wireless terminal A obtains one decoding result. The decoding result includes the one PDCCH data.

As described above, the present invention is also applicable to such a case in which one PDCCH data indicates the identification information of PDSCHs on three components assigned to mobile wireless terminal A. In this case as well, the same effect as described above is obtained.

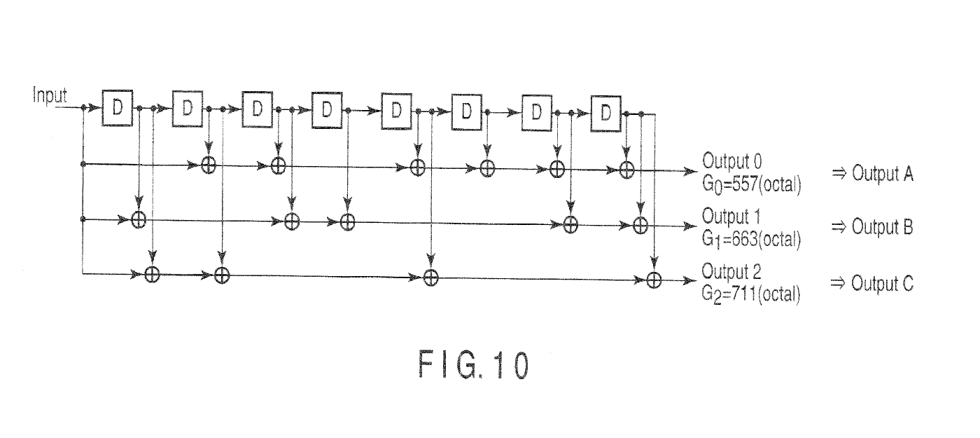

In the above-described embodiment, the wireless base station designates a PUCCH for mobile wireless terminal A using the mapping pattern of PDCCH data corresponding to three components. Instead, for example, error correction coding having such periodicity that makes information before coding correspond to signals obtained by coding is applied as the coding method used by the PDCCH signal generation unit 215 and the control channel decoding unit 115. An example is convolutional coding with tail biting. This coding is done using a coder as shown in FIG. 10.

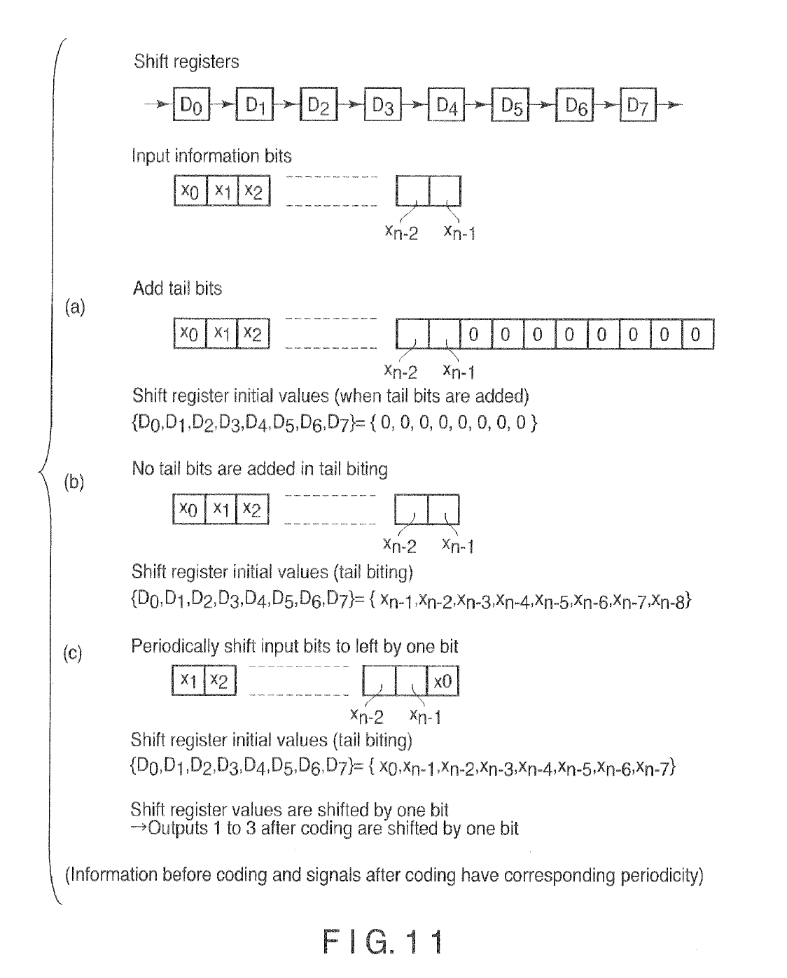

FIG. 10 illustrates the arrangement of a convolutional coder having a coding rate R−⅓ and constraint length 9 (3GPP TS25.212),Information to be coded is input to shift registers having (constraint length−1) stages. Referring to FIG. 10, “D” represents each register. FIG. 11 shows comparison between (a) normal convolutional coding and (b) convolutional coding with tail biting. For the descriptive convenience, FIG. 11 illustrates only the shift register portion in FIG. 10.

In (a) normal convolutional coding, the initial values of shift registers D₀ to D₇ are “0”. Initial values “0” equal in number to the registers are added as tail bits to the end of the information bitstream to be coded. The initial state is restored after the information has been coded. This coding method is often used because the initial and terminal states of the shift registers are known on the receiving side, and therefore, efficient decoding is possible. However, if the number of transfer bits is small, overhead that occurs upon addition of tail bits poses a problem.

On the other hand, in (b) convolutional coding with tail biting, the last portion of the information bitstream to be coded is input as the initial value of each of the shift registers D₀ to D₇, thereby implementing convolutional coding without tail bits. In this case, however, the initial and terminal states are unknown on the receiving side, and the decoding processing is more complex than in (a) coding without tail biting. However, since the transmission power per information bit can be increased without overhead of tail bits, this method has been examined as an effective method and employed in 3GPP LTE (3GPP TS 36.212 V8.3.0).

In (b) convolutional coding with tail biting, if the information bits to be coded are bit-shifted, the shift register states are also bit-shifted. Hence, Outputs A, B, and C of the convolutional coder shown in FIG. 10 are signals bit-shifted to the same degree, too. More specifically, the information bits are cyclically shifted to the left by, e.g., one bit (the bit at the left end moves to the right end), as indicated by (o). In this case, the Outputs A, B, and C of the convolutional coder are signals bit-shifted to the left by one bit, too. The same concept applies to shift of two or more bits. When the transmitting side bit-shifts a signal, and the receiving side receives and error-correction-decodes it, information bit-shifted to the same degree is obtained.

Placing focus on this characteristic, the wireless base station designates a PUCCH corresponding to one of three components for mobile wireless terminal A by a degree of bit shift.

More specifically, when mobile wireless terminal A uses PDSCHs on three components, the scheduler in the control unit 200 designates, in the PDCCH signal generation unit 215, a degree of bit shift corresponding to one PUCCH to be used by mobile wireless terminal A. The PDCCH signal generation unit 215 executes coding based on the designated degree of bit shift.

In mobile wireless terminal A, the control channel decoding unit 115 executes decoding corresponding to coding by the PDCCH signal generation unit 215 and detects a degree of bit shift for successful decoding. The control unit 100 determines, based on the detected degree of bit shift, a PUCCH corresponding to a component to be used.

Note that the wireless base station and mobile wireless terminals A have a consensus in advance on the correspondence between a degree of bit shift and a PUCCH to be used. More specifically, each of the wireless base station and mobile wireless terminal A has a table representing the correspondence between a degree of bit shift and a PUCCH to he used.

As described above, when employing the coding method having such periodicity that makes information before coding correspond to signals obtained by coding, the same effect can be obtained by causing the wireless base station to designate a PUCCH to be used by mobile wireless terminal A by a degree of bit shift.

In the present invention, instead of causing the wireless base station to designate a PUCCH to be used by mobile wireless terminal A by a mapping pattern or a degree of bit shift, as described above, a PUCCH to be used may be determined in advance for each mobile wireless terminal of type y.

In this case, in accordance with the identification information of mobile wireless terminal A, the wireless base station selectively uses a preset one of PUCCHs corresponding to a plurality of components to be used for data transmission. On the other hand, mobile wireless terminal A uses a predetermined PUCCH assigned to the terminal.

To do this, the control units 100 and 200 detect the setting in advance. The control unit 200 controls the units of the reception system to receive the predetermined PUCCH corresponding to the identification information of mobile wireless terminal A. On the other hand, the control unit 100 controls the units of the transmission system to transmit a response signal using the same PUCCH. This arrangement can also provide the same effect as described above.

Alternatively, the wireless base station and mobile wireless terminal A may make an arrangement in advance so as to use, out of PUCCH corresponding to a plurality of components to be used for data transmission, a PUCCH corresponding to a component located at a predetermined order. In this case as well, the control units 100 and 200 detect the setting in advance. The control unit 200 controls the units of the reception system to receive the predetermined PUCCH corresponding to the component located at the predetermined order. On the other hand, the control unit 100 controls the units of the transmission system to transmit a response signal using the PUCCH corresponding to the component located at the same order. This arrangement can also provide the same effect as described above.

In practicing the present invention, various changes and modifications can be made without departing from the spirit and scope of the invention, as a matter of course.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless transmission apparatus which assigns channels of a plurality of bands to a wireless reception apparatus, notifies the wireless reception apparatus of channel assignment information of each band, and performs data transmission via the assigned channels of the plurality of bands, comprising:
a bit shift unit which cyclically shifts a bitstream that forms the channel assignment information by the number of bits corresponding to a channel to be used by the wireless reception apparatus to transmit a response signal;
a coding unit which codes the channel assignment information shifted by the bit shift unit using a coding method having periodicity before and after coding;
a transmission unit which transmits an output from the coding unit to the wireless reception apparatus; and
a reception unit which receives the response signal from the wireless reception apparatus via a channel corresponding to the number of bits shifted by the bit shift unit.

2. A wireless reception apparatus which receives channel assignment information, recognizes channels of a plurality of bands assigned by a wireless transmission apparatus, and performs data reception via the channels of the plurality of bands, comprising:
a reception unit which receives the channel assignment information;
a shift degree detection unit which detects a degree of shift by cyclically shifting a bitstream that forms the channel assignment information received by the reception unit and performing decoding corresponding to a coding method having periodicity before and after coding; and
a transmission unit which transmits a response signal to the wireless transmission apparatus via a channel corresponding to the degree of shift detected by the shift degree detection unit

3. A wireless communication method of causing a wireless transmission apparatus to assign channels of a plurality of bands to a wireless reception apparatus, notifying the wireless reception apparatus of channel assignment information of each band, and performing data transmission via the assigned channels of the plurality of bands, comprising steps of:
causing the wireless transmission apparatus to cyclically shift a bitstream that forms the channel assignment information by the number of bits corresponding to a channel to be used by the wireless reception apparatus to transmit a response signal;
causing the wireless transmission apparatus to code the channel assignment information shifted in the step of causing the wireless transmission apparatus to cyclically shift a bitstream using a coding method having periodicity before and after coding;
causing the wireless transmission apparatus to transmit an output in the step of causing the wireless transmission apparatus to code the channel assignment information to the wireless reception apparatus;
causing the wireless reception apparatus to receive the information transmitted in the step of causing the wireless transmission apparatus to transmit an output;
causing the wireless reception apparatus to detect a degree of shift by cyclically shifting the bitstream that forms the information received in the step of causing the wireless reception apparatus to receive the information, and perform decoding corresponding to the coding method;
causing the wireless reception apparatus to transmit the response signal to the wireless transmission apparatus via a channel corresponding to the degree of shift detected in the step of causing the wireless reception apparatus to detect a degree of shift; and
causing the wireless transmission apparatus to receive the response signal from the wireless reception apparatus via a channel corresponding to the number of bits shifted in the step of causing the wireless transmission apparatus to cyclically shift a bitstream.
